(19) United States
(12) Patent Application Publication
(10) Pub. No.: US 2007/0233995 A1
(43) Pub. Date: Oct. 4, 2007

(54) Information processing apparatus and memory address space allocation method

(76) Inventors: Hiroshi Yamazaki, Ome-shi (JP); Toshitaka Sanada, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,840

(22) Filed: Feb. 26, 2007

(30) Foreign Application Priority Data
Feb. 28, 2006 (JP) 2006-052042

(51) Int. Cl. G06F 12/00

(52) U.S. Cl. 711/170

(57) ABSTRACT

According to one embodiment, an information processing apparatus includes a processor which make access to memory address space into which a first area allocatable for main storage and a second area allocatable for components inherent in a system and I/O devices are mapped, a physical memory which functions as the main storage, a storage device stored with allocation size information, an allocation unit which allocates the physical memory to the first area using the allocation size, and a changing unit which changes the allocation size information stored in the storage device in accordance with the configuration of I/O devices allocatable for the second area.

### CROSS-REFERENCE TO RELATED APPLICATIONS

This application is based upon and claims the benefit of priority from Japanese Patent Application No. 2006-052042, filed Feb. 28, 2006 the entire contents of which are incorporated herein by reference.

### BACKGROUND

1. Field

One embodiment of the invention relates to an information processing apparatus which is capable of allocating main storage and input/output devices to memory address space and a memory address space allocation method for use with the information processing apparatus.

2. Description of the Related Art

In recent years, various portable information processing apparatuses, such as notebook personal computers, have been developed. Such computers are configured such that I/O devices and the like can be connected to them as required in order to extend their features.

Such I/O devices include ones that function as MMIO (Memory-Mapped Input/Output) devices. The I/O devices that function as MMIO devices are allocated to the memory address space of a processor.

A computer system that supports MMIO devices is disclosed in Jpn. Pat. Appln. KOKAI Publication No. 2003-99388.

Normally, the MMIO support system involves mapping MMIO space as well as space allocated for main storage into the memory addresses that a processor can address.

With a 32-bit processor, the size of memory address space to which the processor can make access is limited up to 4 gigabytes. For this reason, when a physical memory of 4 gigabytes is built into the computer, the size of memory that can be actually used as the main storage is limited to 4 gigabytes minus MMIO address space size. Decreasing the size of MMIO address space will result in an increase in the memory size available as the main storage. However, this will result in failure of MMIO devices to work properly.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of an information processing apparatus to which an embodiment of the invention is applied;

FIG. 2 is a block diagram illustrating the system configuration of the information processing apparatus of FIG. 1;

FIG. 3 is a diagram for use in explanation of the memory address space of the CPU in the information processing apparatus of FIG. 1;

FIG. 4 form a flowchart illustrating the memory address space allocation process carried out by the information processing apparatus of FIG. 1; and

FIG. 5 form a flowchart illustrating the memory address space allocation process carried out by the information processing apparatus of FIG. 1.

### DETAILED DESCRIPTION

Various embodiments according to the invention will be described hereinafter with reference to the accompanying drawings. In general, according to one embodiment of the invention, an information processing apparatus comprises a processor which can make access to memory address space into which a first area allocatable for main storage and a second area allocatable for components inherent in a system and I/O devices are mapped, a physical memory which functions as the main storage, a storage device stored with allocation size information, an allocation unit which allocates the physical memory to the first area using the allocation size, and a changing unit which changes the allocation size information stored in the storage device in accordance with the configuration of I/O devices allocatable for the second area.

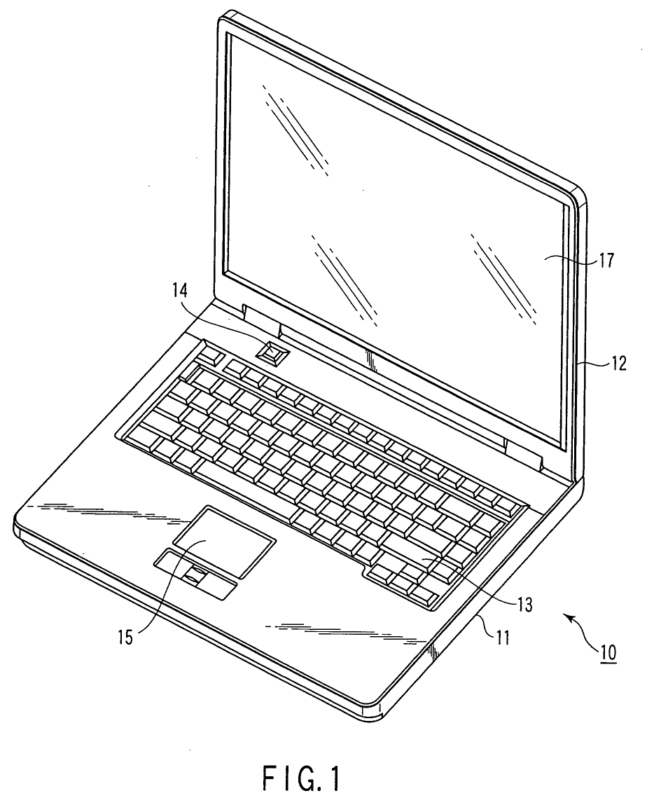

FIG. 1 is a perspective view of an information processing apparatus to which an embodiment of the invention is applied, which is implemented in the form of, for example, a battery-powered notebook personal computer 10. This personal computer is configured such that various I/O devices (optional I/O devices) can be removably attached to it. The optional I/O devices include USB (Universal Serial Bus) devices, card devices which conform to CardBus standards, and card devices which meet PCIExpress (Peripheral Component Interconnect Express) standards.

The computer 10 is constructed from a body 11 and a display unit 12. The body 10 is equipped on top with a key board 13, a power switch 14, and a touch pad 15. On the back of the body 11 are arranged connect ports for connection of optional I/O devices. A display device comprised of an LCD (Liquid Crystal Display) panel 17 is built into the display unit 12. The screen of the LCD panel 17 is positioned almost in the center of the display unit 12. The display unit 12 is rotatably mounted to the body 11 so as to allow the computer to be opened or closed.

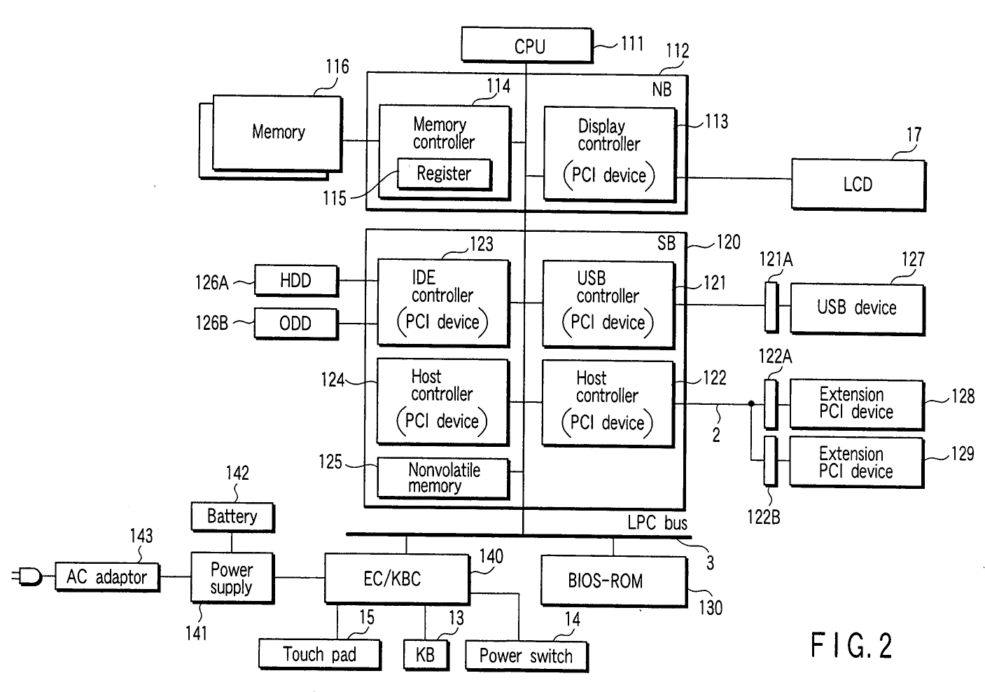

FIG. 2 shows the system configuration of the computer 10.

The computer 10 is composed, as shown in FIG. 2, of a CPU 111, a north bridge (NB) 112, a main memory 116, a south bridge (SB) 120, a hard disk drive (HDD) 126A, an optical disk drive (ODD) 126B, a BIOS-ROM 130, an embedded controller/keyboard controller IC (EC/KBC) 140, etc.

The CPU 111, which is a processor adapted to control the operation of each of the components in the computer 10, executes an operating system (OS) and various application programs which are loaded from the HDD 126A into the main memory 116. The CPU 111 also executes a system NIOS (Basic Input Output System) stored in the BIOS-ROM 136. The system BIOS is a program for hardware control. The system BIOS has a function of displaying on the LCD 17 a BIOS setup menu screen for setting up the operating environment of each component in the computer 10. The CPU 111, which is implemented in the form of, for example, a 32-bit processor, can make access to 4G-byte memory address space. Into this memory address space are mapped a normal memory area which can be allocated for a physical memory used as the main memory (main storage) 116 and an MMIO (Memory-Mapped Input/Output) area which can be allocated for I/O devices such as MMIO devices.

The north bridge 112, which is a bridge device adapted to interconnect the CPU 111 and the south bridge 120, has a display controller 113 and a memory controller 114.

The display controller 112 functions as a PCI device and controls the LCD 17 used as a display monitor of the computer 10. The display controller 112 has a video memory and generates from video data written into the video memory a display signal to be sent to the LCD 17.

The memory controller 114, which is a controller adapted to control the main memory 116, has a register 115. The register 115 is loaded by the system BIOS with address information that designates that area (address range) in the memory address space which can be allocated for the main memory 116 (the starting and ending addresses of the area). When the memory address value output from the CPU 111 is within the address range designated by the address information set in the register 115, the memory controller 114 makes access to the main memory 116.

The main memory 116 is comprised of a physical memory such as a DRAM (Dynamic Random Access Memory). As the physical memory use is made of not only a memory module built into the body 11 but also an extension memory module or modules attached to the body.

To the south bridge 120 are connected to a PCI bus 2 and an LPC (Low Pin Count) bus 3. The south bridge 120 is equipped with a USB controller 121, host controllers 122 and 124, an IDE controller 123, and a nonvolatile memory 125.

The USB controller 121 functions as a PCI device. The USB controller 121 is connected to a USB port 121A to which a USB device 127 that conforms to USB standards can be connected. The USB controller 121 controls an optional I/O device like the USB device 127 connected to the USB port 121A.

The host computer 122 functions as a PCI device and is connected to extension bus slots 122A and 122B via the PCI bus 2. The extension bus slots 122A and 122B are configured so that optional I/O devices, such as Card Bus and PCI Express card devices, can be plugged into them.

The IDE (Integrate Drive Electronics) controller 123 functions as a PCI device and is connected to the HDD 126A and the optical disk drive (ODD) 126B. The IDE controller 123 controls the HDD 126A and the ODD 126B.

The nonvolatile memory 125 stores allocation size information which represents the size of memory allocated for the main memory 116 in the memory address space of the CPU 111. The memory also stores a size information change flag that indicates whether or not a change has been made to the allocation size information. If the allocation size information has been changed, the size information change flag will be set (enabled).

In addition, the nonvolatile memory 125 stores maximum allocatable size information. The maximum allocatable size information represents the memory size which is the size of CPU-accessible memory address space minus the sum of the size of MMIO address space inherent in the system and the size of MMIO address space for PCI devices built in the computer. For example, if the system configuration is such that the CPU 111 is a 32-bit processor, the size of CPU-accessible memory address space is 4 gigabytes, and the address space used for MMIO devices is not less than 0.5 gigabytes (512 megabytes), then the maximum allocatable memory size will be 3.5 gigabytes (3,484 megabytes).

The MMIO address space 204 inherent in the system is memory address space which is allocated to components inherent in the computer 10. For example, to the MMIO address space 204 inherent in the system are allocated PCIEXBAR (Peripheral Component Interconnect Express Base Address), APIC (Advanced Programmable Interrupt Controller), FWH (Firmware Hub) register space and FWBIOS (Firmware Hub BIOS) space. The PCIEXBAR is MMIO address space for accessing a PCI comfit. register. The APIC is MMIO address space for accessing an interrupt controller. The FWH register space is MMIO address space which is allocated for I/O registers in the BIOS-ROM 130. The WHIPS space is MMIO address space which is allocated for a flush memory in the BIOS-ROM 130.

The PCI devices built in the computer refer to memory address space allocated for I/O devices such as PCI devices in the computer 10.

The LPC bus 3 is connected with the BIOS-ROM 130 and the embedded controller/keyboard controller (EC/RBC) 130.

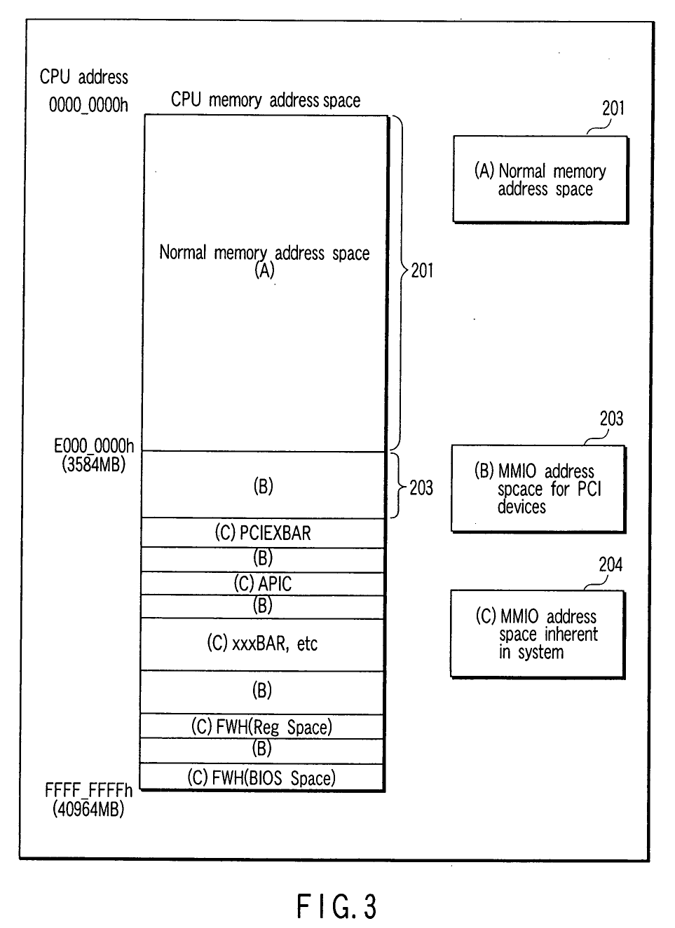

The 32-bit CPU is allowed to make access to only 4-gigabyte space from address 00000000h to FFFFFFFFh as shown in FIG. 3. With personal computers, in order to operate the system, it is required to secure in advance the space 204 for BIOS ROM, APIC, PCIEXBAR (space for accessing the PCI comfit. register as an MMIO device), etc., in fixed relation to the system.

In addition, since the system has some built-in PCI devices, MMIO address space 203 is required for the PCI devices. The 4-gigabyte address space minus the sum of the address space 204 and the address space 201 actually available as memory forms the MMIO address space 203 which can be allocated for the PCI devices.

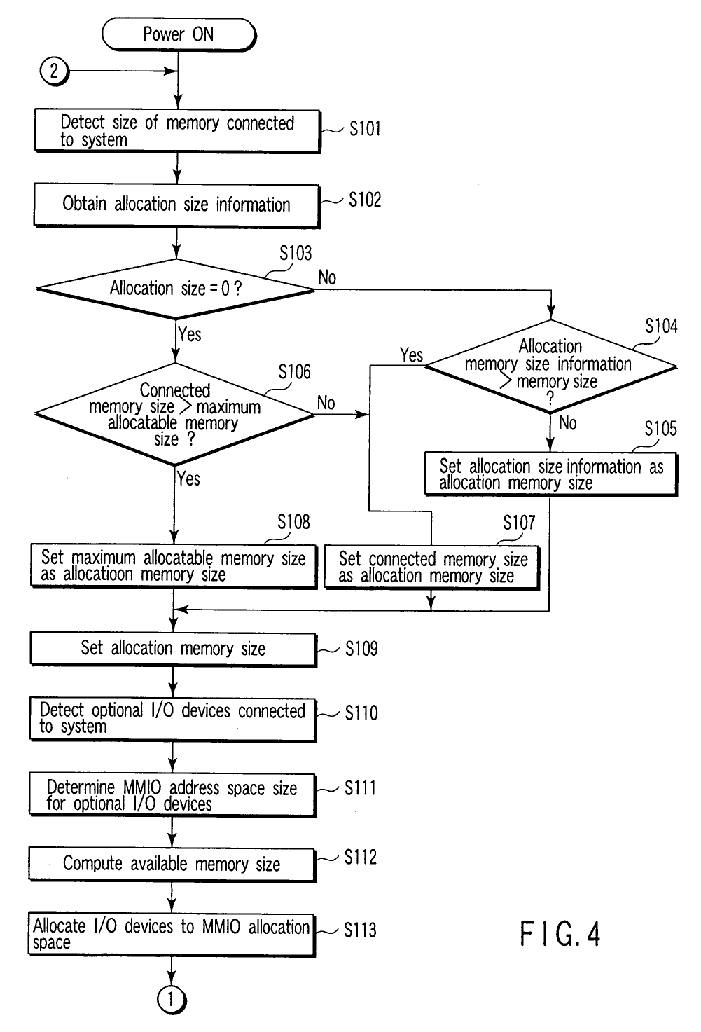

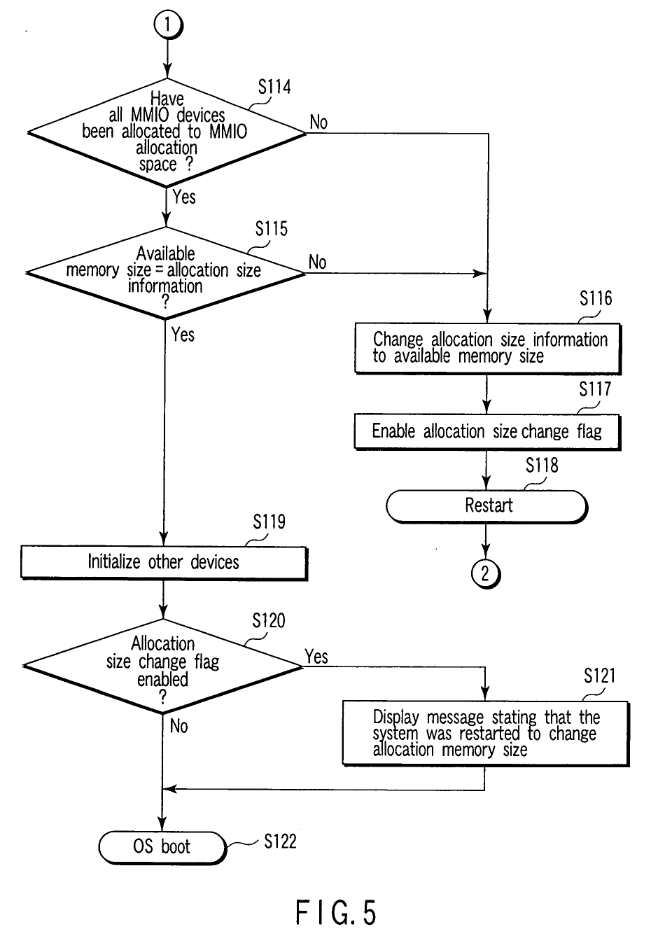

Reference is now made to a flowchart shown in FIGS. 4 and 5 to describe the procedure for determining the memory size in accordance with the invention.

When the power is applied to the PC, the CPU 102 executes the BIOS program stored in the BIOS ROM 106. In the memory initialization process in the BIOS program, the memory 105 is initialized and then the memory size of the memories connected to the system is obtained (block S101). Specifically, in block S101, the system BIOS detects the memory size from an EPROM (Electrically Erasable Programmable Read Only memory), such as SPED (Serial Presence Detect), in the main memory 116.

Reference is made to the allocation size information stored in the nonvolatile memory 125 to store the allocation memory size set to the register 115.

Next, the system BIOS obtains from the nonvolatile memory 125 the allocation size information indicating the memory size which is allocated to the normal memory area (block S102).

Next, the system BIOS makes a decision of whether or not the allocation size information obtained in block S102 indicates 0 (block S103). If not 0 (NO in block S103), that is, if recomputed allocation memory size has been stored, then the system BIOS makes a decision of whether or not the allocation size information obtained in block S102 indicates a value larger than the connected memory size obtained in block S101 (block S104).

If the decision is that the allocation size is not larger than the connected memory size (NO in block S104), then the system BIOS sets the memory size indicated by the allocation memory size information as the memory size to be allocated for the normal memory area.

If, on the other hand, the decision is that the allocation size is larger than the connected memory size (YES in block S104), then the system BIOS sets the connected memory size as the memory size to be allocated form the normal memory area (block S107).

If the decision in block S103 is that the memory size indicated by the allocation memory size information is 0 (YES in block S103), then the system BIOS makes a comparison between the connected memory size and the maximum allocatable memory size stored in the nonvolatile memory 123 to decide whether or not the connected memory size is larger than the maximum allocatable memory size (block S106).

If the decision is that the connected memory size is not larger than the maximum allocatable memory size (NO in block S106), then the system BIOS sets the connected memory size as the allocation memory size (block S107).

If, on the other hand, the decision is that the connected memory size is larger than the maximum allocatable memory size (YES in block S107), then the system BIOS sets the maximum allocatable memory size as the allocation memory size (block S108).

The processes in block s S101 through S108 determine the memory size to be allocated to the normal memory area, thus allowing the MMIO address space that can be allocated to PCI devices to be determined.

After block S105, block S107 or block S109 has been carried out, the system BIOS sets the allocation memory size in the register 115 of the memory controller 114 and then sets the memory size of the main memory 116 to the allocation memory size (block S111). In block S111, the system BIOS stores address information (starting and ending memory addresses) corresponding to the allocation memory size in the register 115.

Next, the system BIOS detects I/O devices connected to the computer 10, i.e., PCI devices built in the computer and optional I/O devices attached to the computer 10 (block S110).

The system BIOS determines the MMIO space size required to allocate all the detected optional I/O devices to memory address space. Then, the system BIOS determines the size of MMIO address space which corresponds to the sum of the determined MMIO address space size and the MMIO space size inherent in the system (block S111).

The system BIOS then calculates the allocatable memory size by subtracting the MMIO address space size obtained in block S111 from the connected memory size obtained in block S101 (block S112).

In accordance with the results of detection in block S110, the system BIOS carries out a memory address allocation process to allocate the I/O devices to the MMIO address space (the MMIO address space 203 for PCI devices and the MMIO address space 204 inherent in the system) (block S113).

The system BIOS makes a decision of whether or not all the I/O devices which function as MMIO devices have been allocated to the MMIO address space (block S114). If the decision is that all the I/O devices which function as MMIO devices have been allocated to the MMIO address space (YES in block S114), then the system BIOS makes a decision of whether or not the allocatable memory size computed in block S112 is equal to the value the allocation size information indicates (block S115).

If, on the other hand, the decision in block S114 is that all the I/O devices which function as MMIO devices cannot be allocated to the MMIO address space (NO in block S114) or if the decision in block S115 is that the allocatable memory size computed in block S112 is not equal to the value the allocation size information indicates (NO in block S115), then the system BIOS changes the allocation size value to an available memory size (block S116). After that, the system BIOS enables the allocation size change flag (block S117) and then makes a restart (block S118). The reason why the restart is required is that the process of setting a memory size in block S109 can be performed only once.

If the decision in block S15 is that the available memory size is equal to the allocation size (YES in block S13), then the system BIOS initializes other components by means of a POST (Power-On Self Test) process by way of example (block S119). A decision is then made as to whether or not the allocation size change flag has been enabled (block S120). If the decision is that the allocation size change flag has been enabled (YES in block S120), a message stating, for example, that the system was restarted for modifying a memory address space assignment is displayed on the LCD 17 (block S121). The system BIOS then disables the assignment size change flag.

If, on the other hand, the decision is block S120 is that the assignment size change flag is not enabled (NO in block S120) or after the process in block S121 has been carried out, the operating system (OS) is booted (block S122).

As described above, by detecting the configuration of PCI devices connected to the system and changing the memory size to be allocated to the main memory 116 in the memory address space of the CPU 111 according to the PCI device configuration, the on-board main memory can be employed in an effective manner. In addition, since the MMIO address space size is allocated by priority, the malfunction of MMIO devices can be prevented.

The memory size assigned for the main memory 116 in the memory address space is reduced below the size of the on-board memory, a message to this effect may be displayed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor which makes access to memory address space into which a first area allocatable for main storage and a second area allocatable for components inherent in a system and I/O devices are mapped;
a physical memory which functions as the main storage;
a storage device stored with allocation size information;
an allocation unit which allocates the physical memory to the first area using the allocation size; and
a changing unit which changes the allocation size information stored in the storage device in accordance with the configuration of I/O devices allocatable for the second area.

2. The information processing apparatus according to claim 1, wherein the changing unit comprises: an allocation size calculation unit which detects I/O devices allocatable to the second area and calculates a size required to allocate the detected I/O devices and components inherent in the system to the second area; a main storage size calculation unit which calculates a memory size available as the main storage from the size calculated by the allocation size calculation unit and the size of the memory address space; a decision unit which makes a decision of whether or not the memory size available as the main storage and the allocation size are equal to each other; and a change unit which changes the allocation size information stored in the storage device through the use of the available memory size, when the result of decision is that the available memory size and the allocation size are not equal to each other.

3. The information processing apparatus according to claim 2, further comprising a restart unit which restarts the system when a change has been made to the allocation size information stored in the storage device.

4. The information processing apparatus according to claim 1, wherein the changing unit comprises: an allocation size calculation unit which detects I/O devices allocatable to the second area and calculates a size required to allocate the detected I/O devices and components inherent in the system to the second area; a main storage size calculation unit which calculates a memory size available as the main storage from the size calculated by the allocation size calculation unit and the size of the memory address space; a decision unit which makes a decision of whether or not the I/O devices have been allocated to the second area; and a change unit which changes the allocation size information stored in the storage device through the use of the available memory size, when the result of decision is that the I/O devices are not allocated to the second area.

5. The information processing apparatus according to claim 4, further comprising a restart unit which restarts the system when a change has been made to the allocation size information stored in the storage device.

6. The information processing apparatus according to claim 1, further comprising a decision unit which makes a decision of whether or not the allocation size is larger than the size of the physical memory, and an allocation whit which, when the decision is that the allocation size is not larger than the size of the physical memory, allocates the physical memory to the first area through the use of the size of the physical memory.

7. The information processing apparatus according to claim 1, further comprising: a second storage device which stores the maximum allocatable memory size which is equal to the size of the memory address space minus the sum of the size required to allocate components inherent in the system to the second area and the size required to allocate I/O devices built into the information processing apparatus to the second area; a first decision unit which makes a decision of whether or not the allocation size is stored in the first storage device; a second decision unit which, when the decision by the first decision unit is that the allocation size is not stored in the first storage device, makes a decision of whether or not the size of the physical memory is larger than the maximum allocatable memory size; a first allocation unit which, when the decision by the second decision unit is that the size of the physical memory is larger than the maximum allocatable memory size, allocates the physical memory to the first area through the use of the maximum allocatable memory size; and a second allocation unit which, when the decision by the second decision unit is that the size of the physical memory is not larger than the maximum allocatable memory size, allocates the physical memory to the first area through the use of the size of the physical memory.

8. An memory address allocation method for use with an information processing apparatus including a processor which make access to memory address space into which a first area allocatable for main storage and a second area allocatable for components inherent in the system and I/O devices are mapped and a physical memory as the main storage, the method comprising;
obtaining an allocation size from a storage device;
allocating the physical memory to the first area using the obtained allocation size;
detecting I/O devices allocatable to the second area; and
changing the allocation size information stored in the storage device in accordance with the detected I/O devices.

9. The method according to claim 8, wherein the changing includes: detecting I/O devices allocatable to the second area; determining a size required to allocate the detected I/O devices and components inherent in the system to the second area; determining a memory size available as the main storage from the determined size and the size of the memory address space; making a decision of whether or not the memory size available as the main storage and the allocation size are equal to each other; and, when the result of decision is that the available memory size and the allocation size are not equal to each other, changing the allocation size information stored in the storage device through the use of the available memory size.

10. The method according to claim 9, further comprising restarting the system when a change has been made to the allocation size information.

11. The method according to claim 7, wherein the changing includes: detecting I/O devices allocatable to the second area; determining a size required to allocate the detected I/O devices and components inherent in the system to the second area; determining a memory size available as the main storage from the determined size and the size of the memory address space; making a decision of whether or not the I/O devices have been allocated to the second area; and, when the result of decision is that the I/O devices are not allocated to the second area, changing the allocation size information stored in the storage device through the use of the available memory size.

12. The method according to claim 11, further comprising restarting the system when a change has been made to the allocation size information stored in the storage device.

13. The method according to claim 7, further comprising making a decision of whether or not the allocation size is larger than the size of the physical memory, and, when the decision is that the allocation size is not larger than the size of the physical memory, allocating the physical memory to the first area through the use of the size of the physical memory.

14. The method according to claim 7, wherein the information processing apparatus has a second storage device which stores the maximum allocatable memory size which is equal to the size of the memory address space minus the sum of the size required to allocate components inherent in the system to the second area and the size required to allocate I/O devices built into the information processing apparatus to the second area, and further comprises: making a decision of whether or not the allocation size is stored in the first storage device; making a decision of whether or not the size of the physical memory is larger than the maximum allocatable memory size when the decision is that the allocation size is not stored in the first storage device; allocating the physical memory to the first area through the use of the maximum allocatable memory size when the decision is that the size of the physical memory is larger than the maximum allocatable memory size; and allocating the physical memory to the first area through the use of the size of the physical memory when the decision is that the size of the physical memory is not larger than the maximum allocatable memory size.
